(19) United States
(12) Patent Application Publication
(10) Pub. No.: US 2006/0274798 A1
(43) Pub. Date: Dec. 7, 2006

(54) Electronic wavelength marker system and method

(75) Inventors: Russ Pritchett, Montara, CA (US); Weizhi Wang, San Jose, CA (US); Jan-Willem Jozef Pieterse, San Jose, CA (US); Andrew H. Cordes, San Jose, CA (US); Rosemary O. Abriam, Livermore, CA (US)

Correspondence Address: MORRISON & FOERSTER LLP, 425 MARKET STREET, SAN FRANCISCO, CA, 94105-2482, US

(73) Assignee: Bookham Technology plc, Towcester (GB)

(21) Appl. No.: 11/404,369

(22) Filed: Apr. 14, 2006

Related U.S. Application Data
(60) Provisional application No. 60/673,268, filed on Apr. 19, 2005.

(51) Int. Cl. H01S 3/10; H01S 3/13; H01S 3/00

(52) U.S. Cl. 372/38.01; 372/20; 372/32

(57) ABSTRACT

A system is provided for producing wavelength tunable laser light and a signal indicative of the wavelength of the produced laser light; a laser cavity includes an optical gain medium and a wavelength selective element disposed in a path of light emitted by the optical gain medium such that changing a position of the element changes a wavelength emitted by the medium; a position sensor that senses position of the element; position signal circuitry that produces a position signal indicative of position of the element sensed by the position sensor; a storage medium storing at least one position signal corresponding to a respective predetermined position of the element; comparison circuitry for comparing the produced position signal with the at least one stored position signal and for producing a comparison result indicative of whether the element has reached to the predetermined position; marker signal circuitry providing an external wavelength marker signal when the comparison result indicates that the element has reached the respective predetermined position.

### CROSS REFERENCE TO RELATED APPLICATION

The present application claims benefit of the provisional patent application, U.S. Application No. 60/673,268, filed Apr. 19, 2005, and entitled “ELECTRONIC WAVELENGTH MARKER SYSTEM AND METHOD,” which provisional patent application is hereby incorporated by reference as if fully set forth herein.

### BACKGROUND OF THE INVENTION

1. Field of the Invention

The present invention relates in general to tunable lasers and, more particularly, to marking the wavelength at which a tunable laser is operating.

2. Description of the Related Art

A tunable laser light source provides wavelength-tunable light. One use of a tunable laser light source, for instance, is to provide light incident upon one or more optical sensors that have an optical property that varies in response to environmental changes. For example, an optical sensor such as a Faber Bragg Grating or a Fabry-Perot element may have an optical property such as transmittance, reflectance, absorbance or polarization of incident radiation that may vary with environmental perturbations such as, temperature, pressure, strain, vibration, acoustics, or other physical parameters.

Specifically, for example, U.S. Pat. No. 5,401,956 to Dunphy et al., entitled, Diagnostic System for Fiber Grating Sensors, teaches a diagnostic system for a fiber-grating sensor using tunable light sources. The system scans the light across a predetermined wavelength range and illuminates each sensor. The disclosed system can operate in a transmission or reflection mode. U.S. Pat. No. 6,204,920 to Ellerbrock et al., entitled, Optical Fiber Sensor System, teaches the use of a tunable light source, e.g., an LED and a tunable etalon, for delivering light to multiple arrays of sensors. U.S. Pat. No. 6,417,507 to Malvern et al., entitled, Modulated Fibre Bragg Grating Strain Gauge Assembly for Absolute Gauging of Strain, discloses use of tunable light sources and frequency modulation to determine absolute direction and magnitude of strain from a ratio of reflected intensity values.

In order to make effective use of tunable laser light it is important to know with an acceptable level of certainty the wavelength to which a laser is tuned. One approach has been to divert a small amount of laser power and to compare it to an external reference using external optical elements. Although this approach can produce an accurate determination of laser wavelength, it can be relatively slow, and the external reference and diversion optics can be relatively expensive. Thus, there has been a need for a faster and cheaper approach to determining the wavelength at which a tunable laser operates.

Moreover, a relatively high wavelength sampling rate often is desirable in order to ensure that a wavelength marker signal is provided sufficiently close to the time when laser light of a tunable laser crosses a predetermined wavelength threshold. However, some earlier processor controlled systems could suffer reduced marker signal accuracy due to execution of unrelated branching statements in the course of wavelength sampling. Thus, there also has existed a need for a consistently an approach to determining the wavelength at which a tunable laser operates that uses a high sampling rate with high accuracy.

The present invention meets these needs.

### SUMMARY OF THE INVENTION

In one embodiment, for example, a system is provided for producing wavelength tunable laser light and a signal indicative of the wavelength of the produced laser light. A laser cavity includes an optical gain medium and a wavelength selective element disposed in a path of light emitted by the optical gain medium such that changing a position of the element changes a wavelength emitted by the medium. A position sensor senses position of the element. Position signal circuitry produces a position signal indicative of position of the element sensed by the position sensor. A storage medium stores at least one position signal corresponding to a respective predetermined position of the element. Comparison circuitry compares the produced position signal with the at least one stored position signal and produces a comparison result indicative of whether the element has reached to the predetermined position. Marker signal circuitry provides an external wavelength marker signal when the comparison result indicates that the element has reached the respective predetermined position. Thus, no external optics are required since the marker signals are produced electronically.

In another aspect of the invention, a processor controls the lasing wavelength through control of the position of the wavelength selective element. The processor also is coupled to provide to the storage medium multiple predetermined position signals each corresponding to a different predetermined position of the element. The storage medium stores the provided multiple position signals. Selection circuitry selects a next stored position signal from among the multiple stored position signals when the comparison result indicates that the element has reached a predetermined position corresponding to a previously selected predetermined position signal. The next stored position signal is compared with subsequently produced position signals until the comparison circuitry indicates that the element has reached a corresponding next predetermined position. The position signal selection process then repeats. Therefore, the selection and comparison circuitry achieve marker signal control largely independent of processor control of lasing wavelength.

In another embodiment, for example, a method is provided for determining wavelength of a light produced by a wavelength tunable laser system that includes a laser cavity including an optical gain medium and a wavelength selective element disposed in a path of light emitted by the optical gain medium such that changing a position of the element changes a wavelength emitted by the medium. A storage medium stores a plurality of predetermined position signals each corresponding to a different predetermined position of the element. A predetermined stored position signal is selected that corresponds to a next predetermined position. The position of the element is changed so as to change the wavelength of light emitted by the laser system. The position of the element is sensed as the element changes position. A position signal is produced that is indicative of the sensed position of the element. The produced position signal is compared with the selected stored predetermined position signal. An external marker signal is produced that is indicative of the wavelength of light emitted by the laser system when the comparison indicates that the element has reached a respective predetermined position that corresponds to the selected predetermined position signal. No external reference and diversion optics are required.

These and other features and advantages of the invention will be apparent from the following detailed description in conjunction with the appended drawings.

### BRIEF DESCRIPTION OF THE DRAWINGS

FIG. 1 is an illustrative block diagram of a laser system in accordance with an embodiment of the invention.

FIG. 2 is an illustrative drawing of a position sensor that may be employed in the embodiment of FIG. 1.

FIG. 3 is an illustrative functional block diagram of the marker signal generating circuit of an embodiment of FIG. 1.

FIG. 4 is illustrative of a more detailed block diagram of the marker signal generating circuit of FIG. 3.

FIG. 5 is an illustrative drawing of a laser cavity based on the Littman-Metcalf design that can be employed in the embodiment of FIG. 1.

FIG. 6 is an illustrative drawing of a laser cavity based on a Littrow configuration that can be employed in the embodiment of FIG. 1.

FIGS. 7A-7B are illustrative drawings of a laser cavity embodiment, employing a filtering element, that can be employed in the embodiment of FIG. 1.

### DETAILED DESCRIPTION OF THE PREFERRED EMBODIMENTS

The present invention provides a novel apparatus and method to ascertain and mark the wavelength at which a tunable laser system is operating. The following description is presented to enable any person skilled in the art to make and use the invention. The embodiments of the invention are described in the context of particular applications and their requirements. These descriptions of specific applications are provided only as examples. Various modifications to the preferred embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles and features disclosed herein.

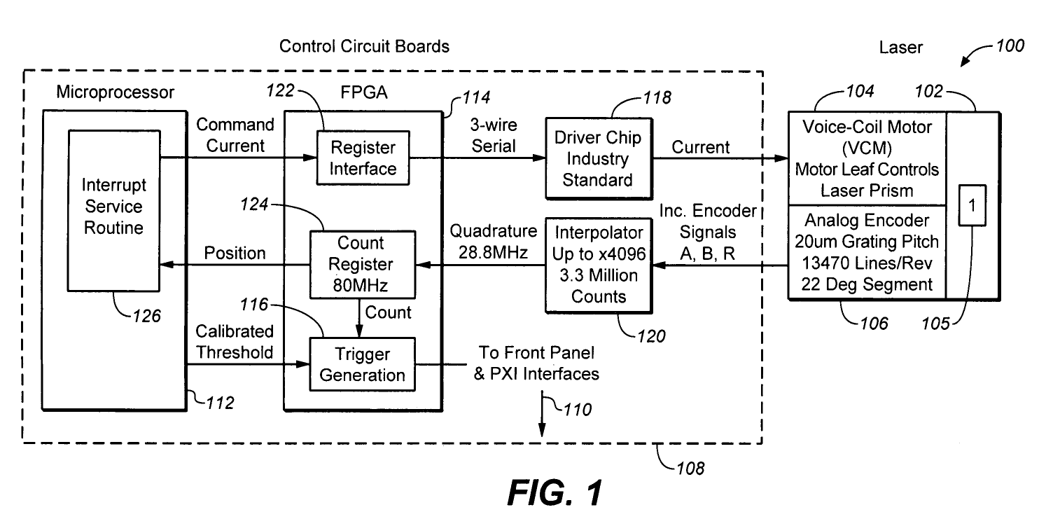

FIG. 1 is an illustrative block diagram of a laser system 100 in accordance with an embodiment of the invention. The laser system 100 includes a laser cavity 102, an actuator 104 to adjust the position of a laser wavelength selection element 105 e.g., a prism, grating or filter (not shown), within the cavity, a sensor 106 to sense the actual position of the wavelength selection element 105 and a position control system 108 that provides a control signal to the actuator 104 and receives a feedback signal from the position sensor 106. The position of the wavelength selection element 105 determines the wavelength at which the laser system operates. The control system 108 provides an actuator control signal that commands the actuator 104 to change the position of the wavelength selection element 105. The control system 108 receives a feedback signal from the position sensor 106 that indicate the actual position of the wavelength selection element 105. The control system 108 may use the position feedback signals to calculate what command signals to send, for example.

The control system 108 also provides on line 110 a wavelength marker signal indicative of the wavelength of laser light emitted by the laser cavity 102. A wavelength marker signal can be provided to an external system, which forms no part of the present invention, to trigger data acquisition or to trigger some other operation in response to some prescribed laser wavelength indicated by the marker signal. More specifically, for instance, an external instrument may be configured to perform some other function whenever the laser light emitted by the laser cavity 102 crosses certain wavelengths. The marker signal may indicate such wavelength crossings. In one embodiment, a wavelength marker signal is provided when a feedback signal provided by the position sensor 106 indicates that the wavelength selection element 105 has reached some predetermined position. More specifically, the laser system 100 is pre-calibrated by predetermining wavelengths at which the laser cavity 102 lases for each of a plurality of different wavelength selection element 105 positions sensed by the position sensor 106. Thus, pre-calibration identifies predetermined wavelengths and corresponding predetermined wavelength selection element positions.

Therefore, the marker signal indicates when wavelength selection element 105 position corresponds to a predetermined element position that, in turn, corresponds to a predetermined wavelength. However, it will be appreciated from the following discussion that it is not critical to the invention whether the marker signal indicates an exact wavelength selection element position or only a close approximation of the element position. For example, the position sensor 106 may not be sufficiently sensitive or otherwise capable of determining with high precision when the element 105 is at an exact predetermined position. Thus, the marker signal may be produced based upon an approximation of wavelength selection element position that is within an acceptable range of error. In one embodiment, the marker signal indicates about when an actual laser wavelength crosses a predetermined wavelength value.

The control system 108 includes a processor 112 coupled to interface circuit 114 and to marker signal generating circuit 116. The control system 108 also includes driver circuit 118 coupled to receive control information from the interface circuit 114 and to provide a control signal to the actuator 104, which controls wavelength selection element position. The control system 108 further includes a converter circuit 120 that converts analog position information produced by the position sensor 106 to a digital signal and that provides the digital signal as feedback to the interface circuit 114.

More particularly, the interface circuit 114 includes a register interface circuit 122 and a count register circuit 124. The register interface circuit 122 receives digital command signals from the processor 112 and provides the received digital command signals to the driver circuitry 118. The count register circuit 124 receives digital count feedback signals from the converter 120 and provides signals representing the feedback count to the processor 112 and to the marker signal generating circuit 116.

The marker signal circuit 116 produces a marker signal based upon the sensed position of the wavelength selection element 105. In one embodiment, a digital feedback signal produced by the converter circuit 120 produces a digital feedback signal from an analog signal produced based upon a position of the element 105 sensed by the position sensor 106. Moreover, in that embodiment, the marker signal generating circuit 116 is coupled to receive a digital feedback signal in the form of a digital count value via the count register 124.

The processor 112 may be implemented as a microprocessor or microcontroller, for example. In one embodiment, the interface circuit 114 and the marker signal generating circuit 116 are disposed in a field programmable gate array (FPGA) circuit separate from the processor 112. Disposing the interface circuit 114 with its register interface 122 to the driver 118 and its count register interface 124 to the converter 120 on a separate integrated circuit, in essence, abstracts these interfaces from the processor 112, permitting the processor to concentrate on Interrupt Service Routine (ISR) execution. This abstraction of functions can be achieved without using separate IC's, however.

More specifically, the primary role of the processor is to control movement of the wavelength selection element 105 by monitoring feedback signals that indicate position of the element 105 and by issuing command signals that alter the position of the element 105. The processor 112 is encoded to perform an ISR 126 which causes it to periodically sample the count register 124 to ascertain position of the wavelength selection element 105. The processor calculates a position command, which it provides to the register interface circuit 122. The position command is provided to the driver 118 which produces a corresponding control signal to move the element 105 in accordance with the command issued by the processor 112.

The role of the marker signal circuitry 116 is to produce marker signals whenever predetermined wavelength thresholds are crossed. From the following discussion, it will be appreciated that the marker signal circuitry 116 operates substantially independently of the processor 112. That is, the processor 112 does not have to initiate a special ISR for a marker signal to be produced. The marker signal circuitry 116 itself produces marker signals without direct intervention by the processor. Thus, sampling may occur at a high rate with high accuracy undisturbed by branching statements that may be executed by the processor 112. However, the processor 112 does participate in programming of the marker circuit 112 to set it up for operation by initially providing predetermined position signals for storage and by providing and address pointers to storage locations, for example.

In one embodiment, the actuator 104 comprises a voice-coil motor (VCM) in which a motor leaf controls position of the wavelength selection element 105. The driver circuit 118 comprises a current regulator circuit that produces a current at a level that impels the VCM to move the element 105 in accordance with a command provided to the register interface 122 by the processor 112.

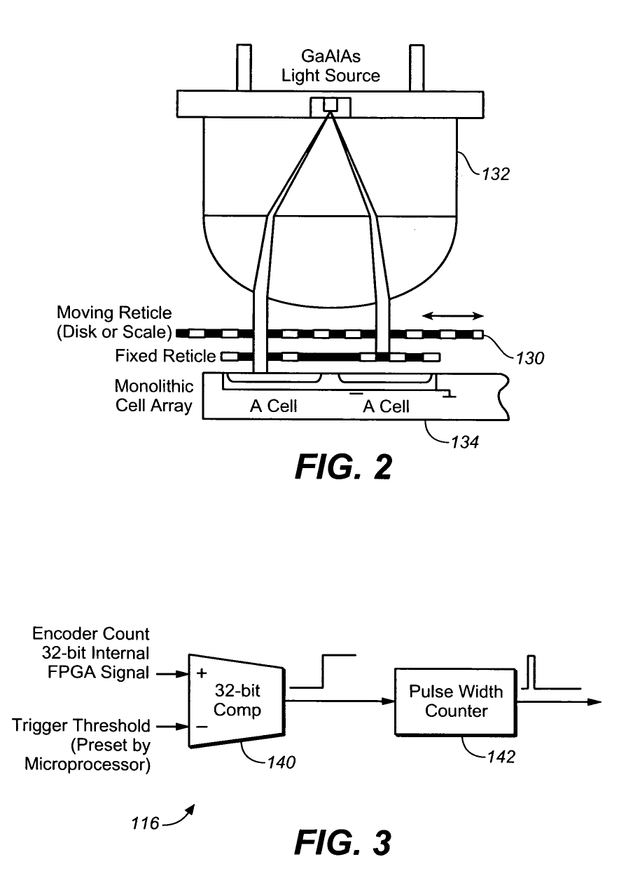

FIG. 2 is an illustrative drawing of a position sensor 106 that may be employed in an embodiment of the invention. The position sensor 106 comprises an optical encoder that converts a mechanical position into a representative electrical signal. The position sensor 106 includes a moving reticle 130 in the form of a patterned disk or scale 130, a light source 132 and first and second photo-sensitive elements 134, 136. The moving reticle 130 is connected to the wavelength selection element 1 OS so that movement of the element causes corresponding movement of the moving reticle 130. The light source 132 and the photo-sensitive elements 134, 136 are fixed in position relative to each other. They do not move relative to the wavelength selection element. In one embodiment the moving reticle 130 is a disk made of glass patterned with a track of alternating dark and light lines around its periphery. Light can pass through the light lines but not through the dark lines. A disk count is defined as the number of dark/light line pairs per revolution. A second track may be added as an index, which can be used to indicate absolute position.

In operation, as the wavelength selection element 105 moves, the moving reticle 130 moves with it. As the element 105 moves, the light and dark pattern, on the moving reticle 130 alternately passes and blocks light emanating from the light source 132 toward the first and second photo-sensitive elements 134, 136. A fixed reticle 138 isolates the first and second photo-sensitive elements 134, 136 so that light illuminating one will not illuminate the other.

In order to derive direction information, the lines on the moving reticle 130 are read out by two different photo-sensitive elements 134, 136 which are disposed relative to each other and the line pairs such that they generate analog signals that are shifted 90 degrees out of phase from each other. These signals are commonly called quadrature signals. The converter circuit 120 comprises an interpolator that receives the 90 degree out of phase analog quadrature signals produced by the position sensor 106 and produces digital quadrature signals indicative of position.

More specifically, in one embodiment, the position sensor 106 includes a moving reticle with a 20-μm grating. The position sensor 106 generates an incremental position signal with 823 periodic cycles (13470 lines/rev*360 deg/rev*1/22 deg segment) over the range of travel of the VCM 104. The interpolator samples the analog position signals to determine discrete positions within each periodic cycle and converts the position signals to digital quadrature position signals. An interpolator of one embodiment is programmable with up to 4096 positions for each cycle (maximum 3,371,008 positions over the VCM range of travel). The maximum output frequency of each quadrature signal is 7.2 MHz: 4 counts are transmitted per quadrature cycle for a maximum of 28.8M counts per second. The count register 124 of the FPGA samples quadrature at 80 MHz and maintains 32-bit registers providing digital count feedback information to the external processor 112 and to marker signal generating circuit 116.

FIG. 3 is an illustrative drawing showing a functional block diagram of the marker signal generating circuit 116 of an embodiment of the invention. In this generalized diagram, the marker signal circuit 116 includes a comparator circuit 140 and a pulse width counter circuit 142. The comparator 140 receives as a positive (+) input digital count feedback value currently stored in the count register 124. The digital count feedback value is indicative of a present position of the wavelength selection element 105. It will be appreciated that the digital count feedback value stored in the count register 124 changes with changes in position of the wavelength selective element 105. The comparator 140 receives as a negative (−) input a predetermined digital value. The predetermined digital value corresponds to a pre-calibrated wavelength selection element position that corresponds to a predetermined laser wavelength. As the position of the wavelength selection element 105 changes and the laser tunes, the digital count stored in the count register 124 changes and is compared to the predetermined digital count value at 25 ns intervals (40 MHz).

In one embodiment, the comparator output signal changes state and produces a trigger edge when the digital count value stored in the register 124 exceeds the predetermined digital value. The pulse width counter circuit 142 provides a specific marker signal pulse width. The marker information is contained in the leading edge of the pulse, however. Thus, the predetermined digital value serves as a trigger value.

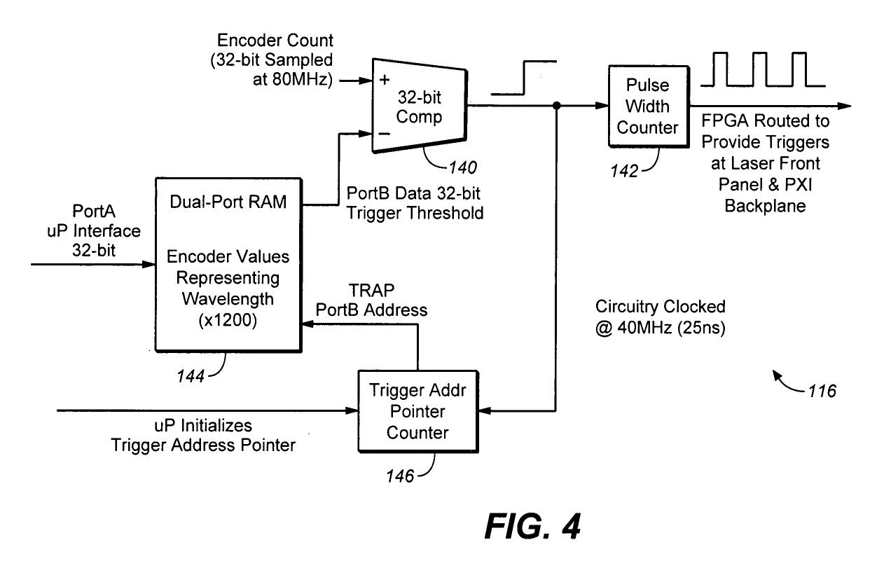

FIG. 4 is an illustrative drawing of a more detailed block diagram of the marker signal generating circuit 116 of FIG. 3. The marker signal circuit 116 includes the comparator circuit 140, the pulse width counter circuit 142, a dual-port RAM circuit 144 and a trigger address pointer counter circuit 146. The processor 112 provides to the data interface of Port A of the RAM 144 a plurality of predetermined digital count values that correspond to wavelengths for which marker signals are to be produced. Each predetermined count value is stored in a different memory location within RM 144. The processor 112 inputs to the trigger address pointer counter circuit 146 information used to initialize an address pointer to a first predetermined count value that is to be compared. The comparator negative (−) input is coupled to receive, via the data interface of Port B of RAM 144, a predetermined count value stored in RAM 144. The received predetermined count value is stored at a memory location pointed to by an address signal provided to an address input of Port B of RAM 144 by the trigger address pointer counter 146.

During operation, the comparator circuit 140 and the pulse width counter circuit 142 operate as described above with reference to FIG. 3. Furthermore, when the comparator output signal changes state and produces a trigger edge, that trigger edge causes the trigger address pointer circuit 146 to increment the address pointer address provided to a Port B address of the RAM 144. In response to the address pointer change, RAM 144 provides a next predetermined digital count value to the negative (−) input of the comparator circuit 140. Thus, the process of comparing digital count feedback signals with predetermined digital count signals continues with the next predetermined digital count value.

It will be appreciated that the configuration of the laser cavity is not important to the invention. The following are brief descriptions of a few different illustrative laser cavity implementations that may be employed consistent with the principles of the invention. Each different configuration can be used to practice the invention even though each employs a somewhat different form of wavelength selection element.

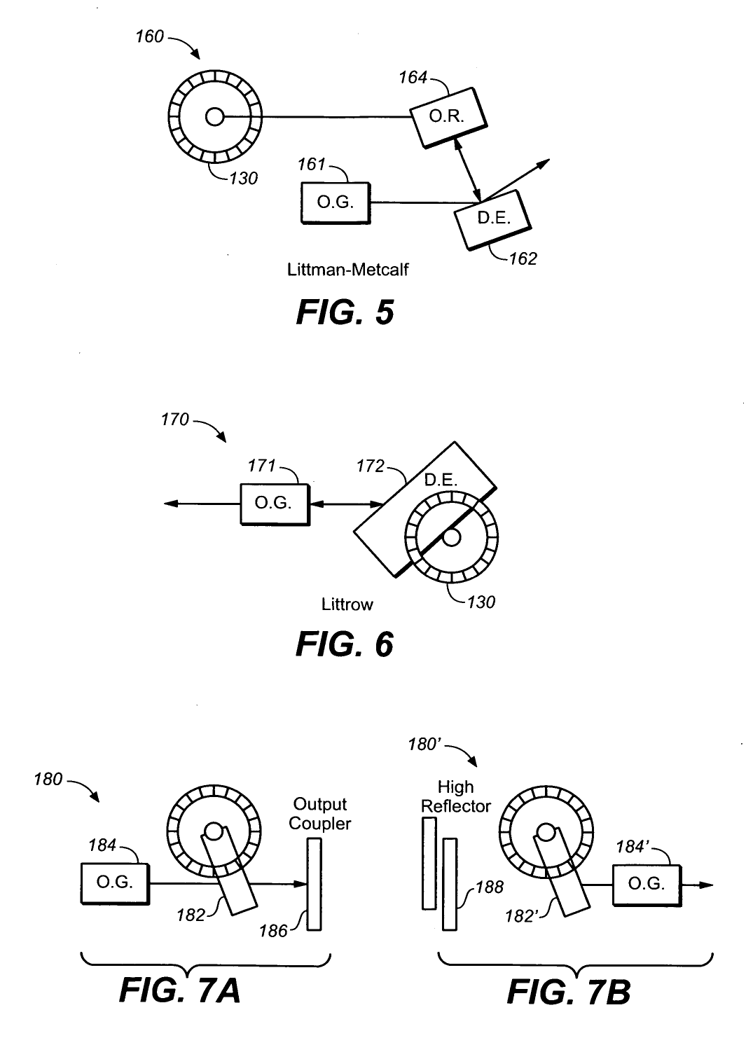

FIG. 5 is an illustrative drawing of a laser cavity 160 based on the Littman-Metcalf design, which uses a diffraction grating at grazing incidence, together with a tuning reflector, to provide wavelength selectivity. An output of an optical gain medium 161, such as a laser diode, is provided across a diffraction grating 162 at a grazing incidence. Dispersion provided by the grating allows only one cavity mode to laser, resulting in a very narrow linewidth. The specular reflection or zero-order diffraction off the grating serves as the output beam of the laser. The angle between the grating and an end mirror 164 determines the lasing wavelength. Laser-cavity length, L, defines a discrete set of possible wavelengths or modes, λ_{N}, that can lase, given by the equation L=Nλ_{N}/2, (N=integer). The grating equation insists that mλ=Λ(sin θ₁+sin θ_{d}), where m stands for the grating diffraction orders. Λ refers to the groove spacing of the grating while θᵢ and θ_{d} refer to the incident and diffracted angles of the laser beam. Rotation of the end mirror tuning reflector 164, which serves as a wavelength selection element, causes parameters in both equations to change. An appropriately selected point of rotation 130 synchronizes the two, such that the cavity length remains the same number of half-wavelengths long as the tuning reflector is rotated. Thus mode-hop free tuning can be achieved. When this condition is not met, the lasing wavelength will periodically hop from one mode to the next (e.g., from N to N+1). grating diffraction orders.

FIG. 6 is an illustrative drawing of another laser cavity embodiment 170 configured to include an external cavity laser diode 171 (an optical gain medium (O.G.)) in a Littrow configuration. A resonant cavity extends from the laser diode 171 to the diffraction grating 172, which serves as a wavelength selection element. First-order diffraction from the grating (diffraction element (D.E.)) 172 is diffracted back on itself. Zero-order diffraction is diffracted in a different direction and can serve as a laser output, for example. The laser cavity 170 operates in a single longitudinal mode by creating a wavelength-dependent loss within the laser cavity. Basically, the diffraction grating 172 serves as a wavelength selective mirror, that is, rotatable about axis 130, and that selectively feeds back a desired wavelength into the laser diode 171. Thus, the gain at the desired wavelength is increased, and a corresponding mode is preferred. Selecting a desired wavelength also sets a corresponding resonant frequency within the resonant cavity 170. The retro-reflection of first-order light occurs when,
mλ=2d sin α
where m is the order of diffraction (after feedback, m=1), d is the grating constant, α is the angle of incidence and λ is wavelength.

FIGS. 7A-7B are illustrative drawings of two laser cavity embodiments 180, 180′ in which a filtering element 182, 182′ serves as a wavelength selection element. In the embodiment of FIG. 7A, the filtering element 182 is disposed between an optical gain medium 184 and an output coupler 186. In the embodiment of FIG. 7B, the filtering element 182′ is disposed between an optical gain medium 184′ and a highly reflective element 188. The filtering element 182, 182′ can be an interference filter comprising multiple dielectric coatings (e.g., thin film, dichroic or interference filter) on an optical substrate. The wavelength reflection is a function of the angle of the coating layers versus the optical beam. Thus the desired wavelength can be obtained by rotating the filter angle in the beam about rotation axis 130.

Tunability could also be obtained with optical wedged coatings. The coatings change reflectivity characteristics over the length of its substrate. These filters are moving in a linear fashion across the beam.

Alternatives to interference filters are birefringent filters. These devices change the polarization as function of wavelength. The laser emits a preferred wavelength defined by the combination with another polarization sensitive element. The latter could be the gain medium itself.

It will be understood that the foregoing description and drawings of preferred embodiment in accordance with the present invention are merely illustrative of the principles of this invention, and that various modifications can be made by those skilled in the art without departing from the scope and spirit of the invention. For example, a piezoelectric actuator may be employed instead of a VCM or linear motion may be used instead of circular motion.

1. A system for producing wavelength tunable laser light and a signal indicative of the wavelength of the produced laser light comprising:
a laser cavity including an optical gain medium and a wavelength selective element disposed in a path of light emitted by the optical gain medium such that changing a position of the element changes a wavelength emitted by the medium;
a position sensor that senses position of the element;
position signal circuitry that produces a position signal indicative of position of the element sensed by the position sensor;
a storage medium storing at least one position signal corresponding to a respective predetermined position of the element;
comparison circuitry for comparing the produced position signal with the at least one stored position signal and for producing a comparison result indicative of whether the element has reached to the predetermined position;
marker signal circuitry providing an external wavelength marker signal when the comparison result indicates that the element has reached the respective predetermined position.

2. The system of claim 1,
wherein the laser cavity includes an optical gain medium, a reflector and a dispersive element disposed in a Littman-Metcalf configuration in which the wavelength selective element includes the reflector or the dispersive element.

3. The system of claim 1,
wherein the laser cavity includes an optical gain medium and a dispersive element disposed in a Littrow configuration in which the wavelength selective element is the dispersive element.

4. The system of claim 1,
wherein the laser cavity includes an optical gain medium and a filter disposed in an optical cavity configuration in which the wavelength selective element includes the filter.

5. The system of claim 1,
wherein the position signal circuitry includes,
an encoder that produces an analog signal indicative of position of the element sensed by the position sensor; and
interpolator circuitry that produces a digital signal from the produced analog signal; and
wherein the at least one stored position signal is a digital signal.

6. The system of claim 1,
wherein the position signal circuitry includes,
an encoder that produces quadrature signals indicative of position of the element sensed by the position sensor; and
interpolator circuitry that a produces a digital signal from the produced quadrature signals; and
wherein the at least one stored position signal is a digital signal.

7. The system of claim 1,
wherein the position signal circuitry includes,
an encoder that produces an analog signal indicative of position of the element sensed by the position sensor; and
an A/D converter that converts the produced analog signal to a digital signal representing a count value; and
wherein the at least one stored position signal is a digital count value that represents the predetermined position of the element.

8. The system of claim 1,
wherein the position sensor includes,
a reticle that changes position with the element such that position of the reticle is indicative of position of the element;
a light source disposed on one side of the reticle;
a light detector that is disposed on an opposite side of the reticle and that produces a light detector signal indicative of changes in light passing through the reticle with changes in positions of the reticle and the element;
wherein the position signal circuitry includes,
an encoder responsive to the light detector signal that produces quadrature signals indicative of position of the element; and
interpolator circuitry that converts the produced quadrature signals to a digital count value that represents position of the element; and
wherein the at least one stored position signal is a digital count value representing the predetermined position of the element.

9. The system of claim 1 wherein
the marker signal circuitry produces an external wavelength marker signal having a prescribed transition when the comparison result indicates that the element has reached the respective predetermined position.

10. The system of claim 1,
wherein the storage medium stores multiple position signals each corresponding to a different predetermined position of the element; and further including:
selection circuitry for selecting a next at least one stored position signal from among the multiple stored position signals when the comparison result indicates that the element has reached a predetermined position corresponding to a previously selected predetermined position signal.

11. The system of claim 1 further including:
a processor that is coupled to provide to the storage medium multiple predetermined position signals each corresponding to a different predetermined position of the element;
wherein the storage medium stores the provided multiple position signals; and further including:
selection circuitry for selecting a next stored position signal from among the multiple stored position signals when the comparison result indicates that the element has reached a predetermined position corresponding to a previously selected predetermined position signal.

12. The system of claim 1 further including:
an actuator for changing position of the wavelength selective element;

13. The system of claim 1 further including:
a processor that is coupled to provide control signals to the actuator so as to control changing of position of the wavelength selective element by the actuator and that is coupled to receive as feedback the produced position signals indicative of position of the element sensed by the position sensor and that is coupled to provide to the storage medium multiple predetermined position signals each corresponding to a different predetermined position of the element;
wherein the storage medium stores the provided multiple position signals; and further including:
selection circuitry for selecting a next at least one stored position signal from among the multiple stored position signals when the comparison result indicates that the element has reached a predetermined position that corresponds to a previously selected predetermined position signal.

14. The system of claim 1 further including:
an actuator for changing position of the wavelength selective element;
a processor that is coupled to provide control signals to the actuator so as to control changing of position of the wavelength selective element by the actuator and that is coupled to receive as feedback the produced position signals indicative of position of the element sensed by the position sensor and that is coupled to provide to the storage medium multiple predetermined position signals each corresponding to a different predetermined position of the element and that provides a RAM address information signal;
wherein the storage medium includes a RAM that stores the provided multiple position signals; and further including:
selection circuitry that is coupled to receive the RAM address information from the processor and that is coupled to receive the comparison result and that is coupled to provide to the RAM a signal that selects a next at least one stored position signal from among the multiple stored position signals when the comparison result indicates that the element has reached a predetermined position corresponding to a previously selected at least one stored predetermined position signal.

15. A system for producing wavelength tunable laser light and a signal indicative of the wavelength of the produced laser light comprising:
a laser cavity including an optical gain medium and a wavelength selective element disposed in a path of light emitted by the optical gain medium such that changing a position of the element changes a wavelength emitted by the medium;
an actuator for changing position of the wavelength selective element;
a position sensor that senses position of the element;
position signal circuitry that produces a digital position signal indicative of position of the element sensed by the position sensor;
a storage medium that includes a RAM that stores multiple predetermined position signals each comprising a different digital value corresponding to a different predetermined position of the element;
a processor that is coupled to provide control signals to the actuator so as to control changing of position of the wavelength selective element by the actuator and that is coupled to receive as feedback the produced position signals indicative of position of the element sensed by the position sensor and that is coupled to provide to the storage medium the multiple predetermined position signals and that provides a RAM address information signal;
comparison circuitry for comparing the produced digital position signal with a selected stored digital position signal and for producing a comparison result indicative of whether the element has reached a predetermined position that corresponds to a previously selected predetermined position signal;
selection circuitry that is coupled to receive the RAM address information signal from the processor and that is coupled to receive the comparison result and that is coupled to provide a to the RAM an address signal that selects a next stored position signal from among the multiple stored position signals when the comparison result indicates that the element has reached a predetermined position that corresponds to a previously selected stored predetermined position signal; and
marker signal circuitry providing an external wavelength marker signal when the comparison result indicates that the element has reached the respective predetermined position.

16. The system of claim 15 wherein
the marker signal circuitry produces an external wavelength marker signal having a prescribed pulse state transition when the comparison result indicates that the element has reached the respective predetermined position.

17. A system for producing wavelength tunable laser light and a signal indicative of the wavelength of the produced laser light comprising:
a laser cavity including an optical gain medium and a wavelength selective element disposed in a path of light emitted by the optical gain medium such that changing a position of the element changes a wavelength emitted by the medium;
an actuator for changing position of the wavelength selective element;
a position sensor that senses position of the element, wherein the position sensor includes,
a reticle that changes position with the element such that position of the reticle is indicative of position of the element;
a light source disposed on one side of the reticle;
a light detector that is disposed on an opposite side of the reticle and that produces a light detector signal indicative of changes in light passing through the reticle with changes in positions of the reticle and the element;
position signal circuitry that produces a position signal indicative of position of the element sensed by the position sensor, wherein the position signal circuitry includes,
an encoder responsive to the light detector signal that produces quadrature signals indicative of position of the element; and
interpolator circuitry that converts the produced quadrature signals to a digital count value that represents position of the element; and
a storage medium that includes a RAM that stores multiple predetermined position signals each comprising a different digital value corresponding to a different predetermined position of the element;
a processor that is coupled to provide control signals to the actuator so as to control changing of position of the wavelength selective element by the actuator and that is coupled to receive as feedback the produced position signals indicative of position of the element sensed by the position sensor and that is coupled to provide to the storage medium the multiple predetermined position signals and that provides a RAM address information signal;
comparison circuitry for comparing the produced digital position signal with a selected stored digital position signal and for producing a comparison result indicative of whether the element has reached a predetermined position that corresponds to a previously selected predetermined position signal;
selection circuitry that is coupled to receive the RAM address information signal from the processor and that is coupled to receive the comparison result and that is coupled to provide a to the RAM an address signal that selects a next stored position signal from among the multiple stored position signals when the comparison result indicates that the element has reached a predetermined position that corresponds to a previously selected stored predetermined position signal; and
marker signal circuitry providing an external wavelength signal when the comparison result indicates that the element has reached the respective predetermined position.

18. A system for producing wavelength tunable laser light and a signal indicative of the wavelength of the produced laser light comprising:
a laser cavity including an optical gain medium and a wavelength selective element disposed in a path of light emitted by the optical gain medium such that changing a position of the element changes a wavelength emitted by the medium;
means for changing position of the wavelength selective element;
means for sensing position of the element;
means for producing a position signal indicative of position of the element sensed by the position sensor;
means for storing at least one position signal corresponding to a respective predetermined position of the element;
comparison means for comparing the produced position signal with the at least one stored position signal and for producing a comparison result indicative of whether the element has reached to the predetermined position; and
means for providing an external wavelength marker signal when the comparison result indicates that the element has reached the respective predetermined position.

19. A method of determining wavelength of a light produced by a wavelength tunable laser system that includes a laser cavity including an optical gain medium and a wavelength selective element disposed in a path of light emitted by the optical gain medium such that changing a position of the element changes a wavelength emitted by the medium, the method comprising:
(A) storing in a storage medium a plurality of predetermined position signals each corresponding to a different predetermined position of the element;
(B) selecting a predetermined stored position signal that corresponds to a next predetermined position;
(C) changing the position of the element so as to change the wavelength of light emitted by the laser system;
(D) sensing position of the element as the element changes position;
(E) producing a position signal indicative of the sensed position of the element;
(F) comparing the produced position signal with the selected stored predetermined position signal;
(G) producing an external marker signal indicative of the wavelength of light emitted by the laser system when the comparison indicates that the element has reached a respective predetermined position that corresponds to the selected predetermined position signal.

20. The method of claim 19,
wherein step (C), changing the position of the element, includes continuously changing the position of the element (or laserlight??) over a prescribed range;
(H) selecting a different predetermined stored position signal that corresponds to a different predetermined position;
(I) repeating steps (D)-(H) during the step (C) of changing position of the element.

21. The method of claim 19 further including:
using the produced position signal by a processor as feedback to control position of the element.
